(19) United States
(12) Patent Application Publication
(10) Pub. No.: US 2014/0132815 A1
(43) Pub. Date: May 15, 2014

(54) Digital camera structure capable of selectively mounting a camera lens

(71) Applicant: Meizhou XiuYing Enterprise Company Limited, Shenzhen City (CN)

(72) Inventor: Tau-Jeng Hsu, Shenzhen City (CN)

(73) Assignee: Meizhou XiuYing Enterprise Company Limited, Shenzhen City (CN)

(21) Appl. No.: 14/164,283

(22) Filed: Jan. 27, 2014

(51) Int. Cl. H04N 5/225

(52) U.S. Cl. CPC H04N 5/2253; H04N 5/2252
USPC 348/308

(57) ABSTRACT

A digital camera structure is provided with a housing and at least one optical assembly. The housing defines a substantially inverted cone-shaped recess at its front that accommodates therein a CMOS image sensor being electrically connected to a control board within the housing. The optical assembly is selectively and releasably mounted into the inverted cone-shaped recess corresponding to the CMOS image sensor. The optical assembly is constructed of a wide-angle lens module for providing a wider angle of view, a telephoto lens module for bringing distant objects closer, a close-up lens module for monitoring miniature objects, or a filtering module for reducing undesired light.

### BACKGROUND OF THE INVENTION

1. Field of the Invention The invention relates to a digital camera structure and more particularly to a digital camera structure that can be selectively and releasably mounted with a specific optical assembly to meet a user's need.

2. Description of Related Art

Currently, complementary metal-oxide-semiconductor (CMOS) image technology has been widely used in digital cameras, which generally have a larger size of image sensor. Although a larger image sensor has an advantage of higher resolution, its associated digital camera will become larger accordingly. Besides, the optical lenses mounted on the existing digital cameras usually have a fixed focal length or they have a variable focal length but only with telephoto function. Thus, the existing digital cameras cannot be applied to a photographic application requiring a wide angle of view, a macro view, or a light attenuation. As such, a user should carry another high-level professional camera, which is usually heavy and large. Or alternatively, the user should mount a wide-angle or fish-eye lens through an external adapter to meet the demands of the photographic application, and this will increase the volume of the associated digital camera and the cost of the photographic application, which in turn causes inconvenience of carrying and operating the device.

Thus, the need for improvement still exists.

### SUMMARY OF THE INVENTION

It is therefore one object of the invention to provide a digital camera structure that makes use of the camera's limited space to allow a CMOS image sensor to be properly located therein, and to allow the CMOS image sensor to be cooperated with various types of optical assemblies, each containing a specific high-level optical lens module for obtaining a desired viewing effect, such as standard viewing, wide-angle viewing, telephoto viewing, close-up viewing, and light attenuation, whereby the photographing or videoing function of the digital camera can be increased significantly.

To achieve the above object, the digital camera structure comprises a housing and at least one optical assembly. The housing defines a substantially inverted cone-shaped recess at its front that accommodates therein a CMOS image sensor being electrically connected to a control board within the housing. The optical assembly is selectively and releasably mounted into the inverted cone-shaped recess corresponding to the CMOS image sensor, wherein the optical assembly is constructed of a wide-angle lens module for providing a wider angle of view, a telephoto lens module for bringing distant objects closer, a close-up lens module for monitoring miniature objects, or a filtering module for reducing undesired light.

The above and other objects, features and advantages of the invention will become apparent from the following detailed description taken with the accompanying drawings.

### BRIEF DESCRIPTION OF THE DRAWINGS

FIG. 1 is an exploded view of one embodiment of the invention;

FIG. 2 is an assembled view of the embodiment of the invention;

FIG. 3 is a perspective view of the embodiment of the invention, which is viewed from the back of the digital camera;

FIG. 4 shows a sectional view of the embodiment of the invention, wherein the optical assembly is taken from the housing of the digital camera structure; and

FIG. 5 is another sectional view of the embodiment of the invention, wherein the optical assembly is mounted into the housing of the digital camera structure.

### DETAILED DESCRIPTION OF THE INVENTION

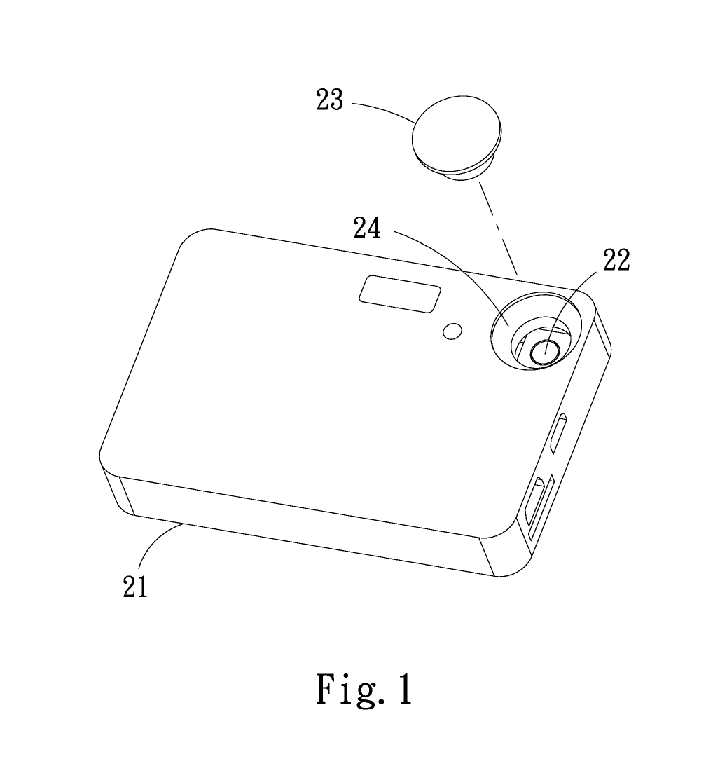

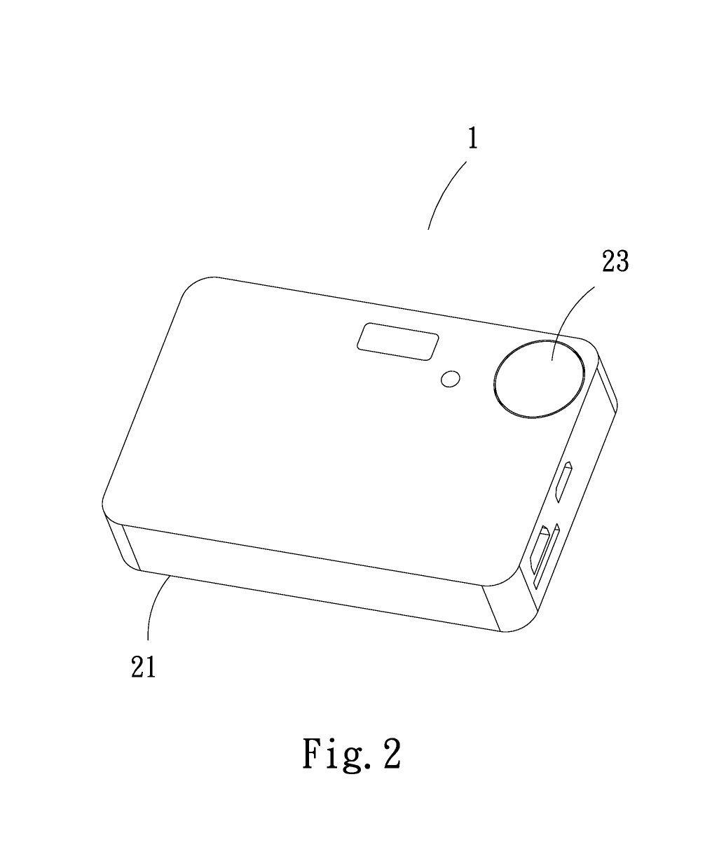

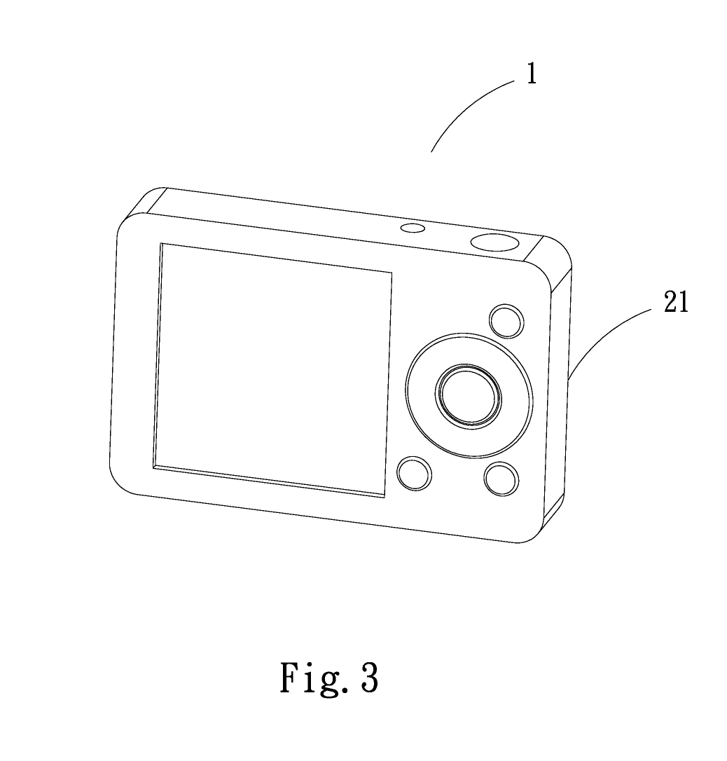

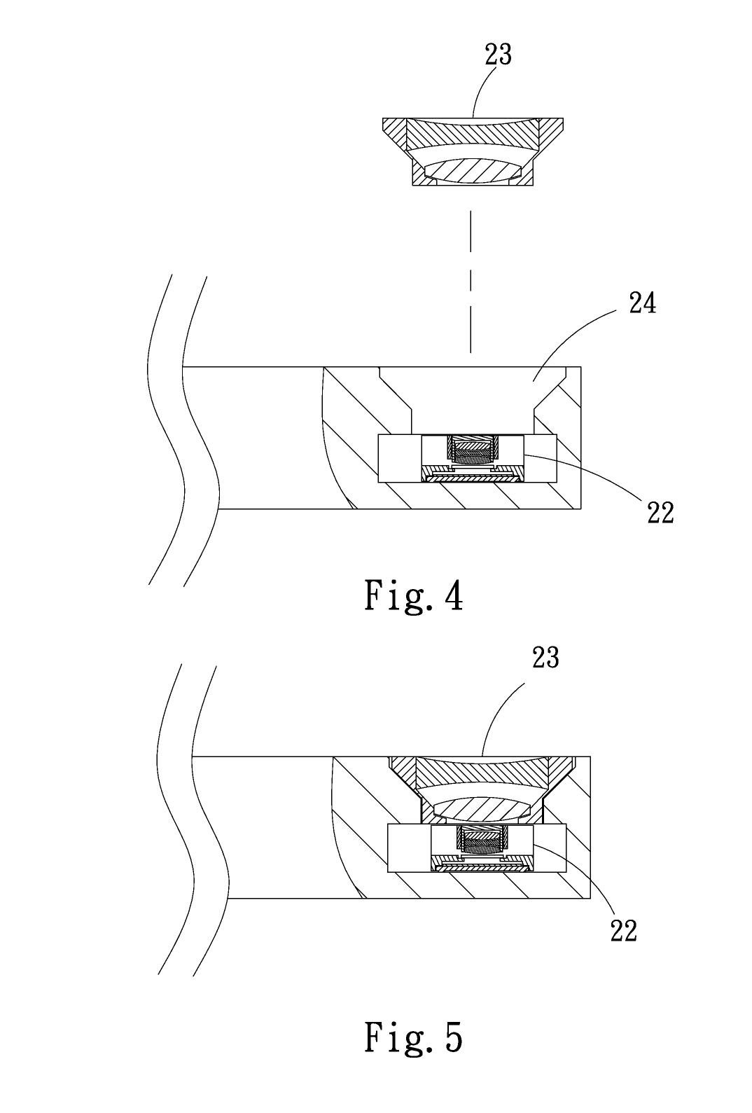

Referring to FIGS. 1 to 5, a digital camera structure in accordance with the invention comprises a housing 21 and at least one optical assembly 23. The housing defines a substantially inverted cone-shaped recess 24 at its front that accommodates therein a CMOS image sensor 22 being electrically connected to a control board (not shown) within the housing 21. Preferably, the CMOS image sensor 22 is located at an innermost part of the recess 24. The optical assembly 23 is selectively and releasably mounted into the inverted cone-shaped recess 24, corresponding to the CMOS image sensor 22, to allow the optical assembly 23 to be in flush with the front surface of the housing 21 after mounting the assembly. The optical assembly 23 can be constructed of a wide-angle lens module for providing a wider angle of view, a telephoto lens module for bringing distant objects closer, a close-up lens module for monitoring miniature objects, or a filtering module for reducing undesired light. More specifically, the optical assembly 23 can be releasably mounted into the inverted cone-shaped recess 24 of the housing 21 via spring means, thread means, engagement means, locking means, or frictional rubber means. With the invention, a user can easily replace the optical assembly being currently used with another optical assembly having a different optical feature.

Currently, CMOS image technology has been widely used in digital cameras, which generally have a larger size of image sensor. Although a larger image sensor has an advantage of higher resolution, its associated digital camera will become larger accordingly. Besides, the optical lenses mounted on the existing digital cameras usually have a fixed focal length or they have a variable focal length but only with telephoto function. Thus, the existing digital cameras cannot be applied to a photographic application requiring a wide angle of view, a macro view, or a light attenuation. As such, a user should carry another high-level professional camera, which is usually heavy and large. Or alternatively, the user should mount a wide-angle or fish-eye lens through an external adapter to meet the demands of the photographic application, and this will increase the volume of the associated digital camera and the cost of the photographic application, which in turn causes inconvenience of carrying and operating the device.

The invention makes use of the camera's limited space to allow the CMOS image sensor 22 to be properly located within the housing 21, and to allow the CMOS image sensor 22 to be cooperated with various types of optical assemblies, each containing a specific high-level optical lens module, for obtaining a desired viewing effect. After mounting the optical assembly 23 into the recess 24, the optical assembly 23 can be located in flush with the front surface of the housing 21. A user can select an optical assembly with a specific optical feature, such as standard viewing, wide-angle viewing, telephoto viewing, close-up viewing, light attenuation and the like, according to a practical requirement, to allow the photographing or videoing function of the digital camera to be significantly increased. The mounting or replacement of an optical assembly for the digital camera is convenient.

Furthermore, since the optical assembly 23 is small, light and easy to store, a user can carry several optical assemblies of various functions or factors easily and conveniently. Each optical assembly can be entirely mounted into the inverted cone-shaped recess 24 to allow the top surface thereof to be in flush with the front surface of the housing 21 of the digital camera. As such, when a user puts the digital camera of the invention into the pockets of the user's trousers, since there is no object protruding from the housing 21 of the digital camera, the user will not feel uncomfortable.

Although the invention has been described in detail, it is to be understood that this is done by way of illustration only and is not to be taken by way of limitation. The scope of the invention is to be limited only by the appended claims.

What is claimed is:

1. A digital camera structure comprising:
a housing and at least one optical assembly;
wherein the housing defines a substantially inverted cone-shaped recess at its front that accommodates therein a CMOS image sensor being electrically connected to a control board within the housing;
wherein the optical assembly is selectively and releasably mounted into the inverted cone-shaped recess corresponding to the CMOS image sensor; and
wherein the optical assembly is constructed of a wide-angle lens module for providing a wider angle of view, a telephoto lens module for bringing distant objects closer, a close-up lens module for monitoring miniature objects, or a filtering module for reducing undesired light.

2. The digital camera structure of claim 1, wherein the optical assembly is releasably mounted into the inverted cone-shaped recess of the housing via spring means, thread means, engagement means, locking means, or frictional rubber means.
